(19) United States
(12) Patent Application Publication
(10) Pub. No.: US 2007/0177452 A1
(43) Pub. Date: Aug. 2, 2007

(54) Flow Homogenizer

(75) Inventor: Abdelwahab Aroussi, Radford, Nottingham (GB)

Correspondence Address: C. ROBERT VON HELLENS;CAHILL, VON HELLENS & GLAZER P.L.C., 155 PARK ONE,, 2141 E. HIGHLAND AVENUE, PHOENIX, AZ, 85016, US

(73) Assignee: Gaim Ltd., Woodville, Derbyshire (GB)

(21) Appl. No.: 10/527,444

(22) PCT Filed: Sep. 9, 2003
(86) PCT No.: PCT/GB03/03919

§ 371 Date: Oct. 28, 2005

(30) Foreign Application Priority Data
Sep. 9, 2002 (GB) 0220814.8

(51) Int. Cl. B01F 13/02; B01F 13/00; F24H 9/12

(52) U.S. Cl. 366/101; 138/37; 138/40; 366/107; 366/341

(57) ABSTRACT

A flow homogeniser for insertion in a pipeline conveying a particulate material carried by a carrier fluid comprising a pipe having an inlet end and an outlet end and including a core defined by one or more core pipe sections connected in series between the inlet end and the outlet end, the or each core pipe section defining a relatively gradual or rapid change in cross-sectional area in order to mix particulate material and carrier fluid entering the inlet end to form a homogeneous mixture on exit from the outlet end.

The present invention relates to a flow homogeniser for particulate laden fluid flows.

Pipe networks comprising a network of pipelines are used in many different industries as a means for transporting and distributing particulate material carried by a carrier fluid throughout the network. Typical examples are found in the power generation industry, the chemical industry, the cement industry and the food industry.

Since the networks in many of these applications have pipelines extending along long and tortuous pathways, the particulate material often becomes less diffused within the carrier fluid in which it is carried such that the particulate material becomes concentrated within a region of the pipeline. This leads to a non-homogeneous mix of particulate material throughout the carrier fluid. This can lead to problems such as erosion or maldistribution at splits; namely where a pipeline branches in order to direct the fluid flow to two or more different outlets since, if the particulate material is not distributed uniformly throughout the carrier fluid, the particulate material will not be divided equally between the outlets.

In coal-fired power stations, for example, coal is pulverised in coal mills and then pneumatically transported and distributed to burners in a boiler. One coal mill typically supplies 4-8 burners with pulverised fuel (PF). The burners are distributed in rows on one face of the boiler or on all the corners of the boiler. This means that the network of pipelines connecting the coal mill to the burners includes bends and elbows of various shapes, and splitters, in order to distribute PF to each burner.

The length of the pipelines in the network, together with the tortuous path that they follow, modifies the nature of the PF flow dramatically. In particular, the centrifugal forces acting on the particulate matter at bends in the network gives rise to an effect known as roping where the PF becomes concentrated within a region of the pipeline, taking up only a small proportion of the pipeline cross-sectional area. The two-phase flow (air/coal) therefore changes from a relatively homogeneous flow starting from the coal mill to a roping flow after travelling through a relatively small number of bends in the pipeline.

On arriving at branching or splitting points in the network (e.g. bifurcations, trifurcations, quadrafurcations and so on) the non-homogeneous PF flow is split into uneven fuel/air ratios to feed different burners.

Splitting the fuel from a primary PF pipe to subsequent pipelines, often using a series of splits, with a mass split of 60%:40% for each split, can having a significant effect on the boiler performance and power station efficiency.

The combustion control of the boiler does not often know the amount of PF supplied to each individual burner, and it is sometimes difficult to accurately proportion, between the burners, the common air supply. The local effect at the burners therefore is an incorrect mixture of PF and air.

This yields uneven combustion in the burners and an imbalance in the boiler combustion, particularly for wall-fired boilers. In turn, this increases fuel costs and levels of carbon in the ash, as well as the emission of pollutants in the flue gas such as nitrogen oxide, which is particularly problematic since there are increasingly stringent regulations for pollutant emissions.

One method of combating the problem of non-homogeneous flow in networks of pipelines is to minimise the number of bends and splits in the pipelines of the network. However, established industrial plants, such as power stations, usually have an elaborate network of pipelines. To reduce the number of points where the fluid flow splits would require total replacement of the network at a considerable cost.

An aim of the present invention is to provide a flow homogeniser for insertion into a pipeline transporting and distributing a particulate material carried by a carrier fluid in order to mix the multi-phase flow and produce a homogeneous distribution of the particulate material within the carrier fluid.

According to an aspect of the invention there is provided a flow homogeniser for insertion in a pipeline conveying a particulate material carried by a carrier fluid comprising a pipe having an inlet end and an outlet end and including a core defined by two or more core pipe sections connected in series between the inlet end and the outlet end, the or each core pipe section defining a relatively gradual or rapid change in cross-sectional area in order to mix particulate material and carrier fluid entering the inlet end to form a homogeneous mixture on exit from the outlet end.

The flow homogeniser permits the mixing of particulate material and carrier fluid in a pipeline without the need for any external device or external energy consumption.

References to a gradual change in cross-sectional area throughout the claims and the description is intended to mean a rate of change in cross-sectional area which results in the exterior wall of the core pipe section defining an angle which is less than 40° to the axis of the core pipe section. For example, in a preferred embodiment, the exterior wall of the core pipe section may define an angle of approximately 6° to the axis of the core pipe section.

References to a rapid change in cross-sectional area throughout the claims and the description is intended to mean a rate of change in cross-sectional area which results in the exterior wall of the core pipe section defining an angle which is greater than 40° to the axis of the core pipe section. For example, in a preferred embodiment, the exterior wall of the core pipe section may define an angle of approximately 45° to the axis of the core pipe section.

In a preferred embodiment, the cross-sectional area of a core pipe section extending from the inlet end increases from the cross-sectional area of the inlet end to a relatively larger cross-sectional area. This arrangement helps to minimise any back pressure in the carrier fluid which may be created due to the change in cross-sectional area as the carrier fluid enters the inlet end.

Preferably the cross-sectional areas of the inlet and outlet ends are equal. This ensures that any change in pressure in the carrier fluid over the flow homogeniser is minimised, and thereby ensures that any change in the carrier fluid flow rate between the carrier fluid flow rate immediately upstream of the inlet and the carrier fluid flow immediately downstream of the outlet end is minimised.

The carrier fluid may be a gas, and is preferably air. However, the invention is also applicable to arrangements where the carrier fluid is a liquid.

Embodiments of the invention will now be described, by way of non-limiting examples, with reference to the accompanying drawings in which:

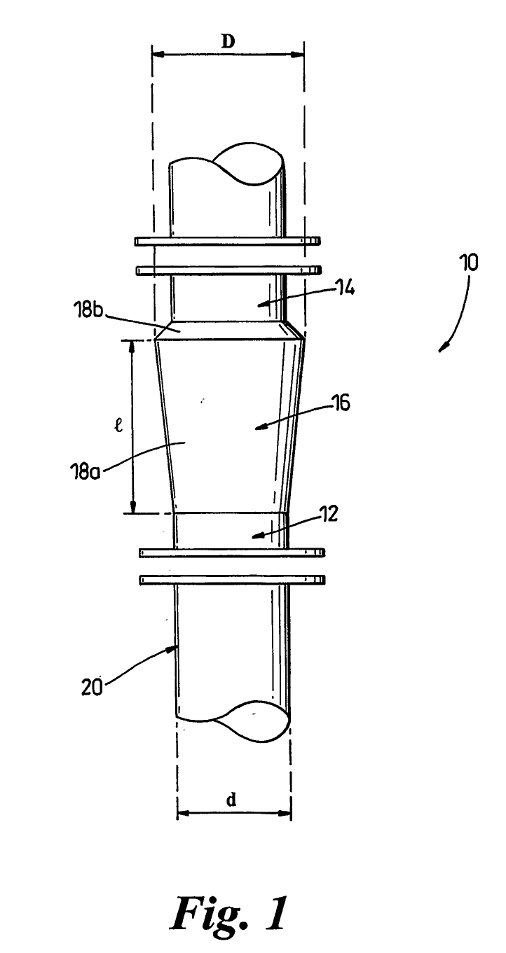

FIG. 1 shows a flow homogeniser according to an embodiment of the invention;

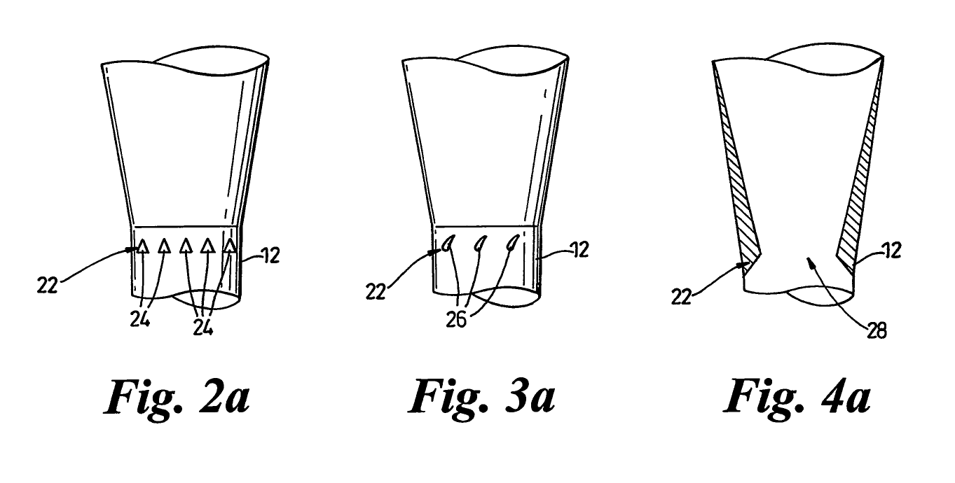

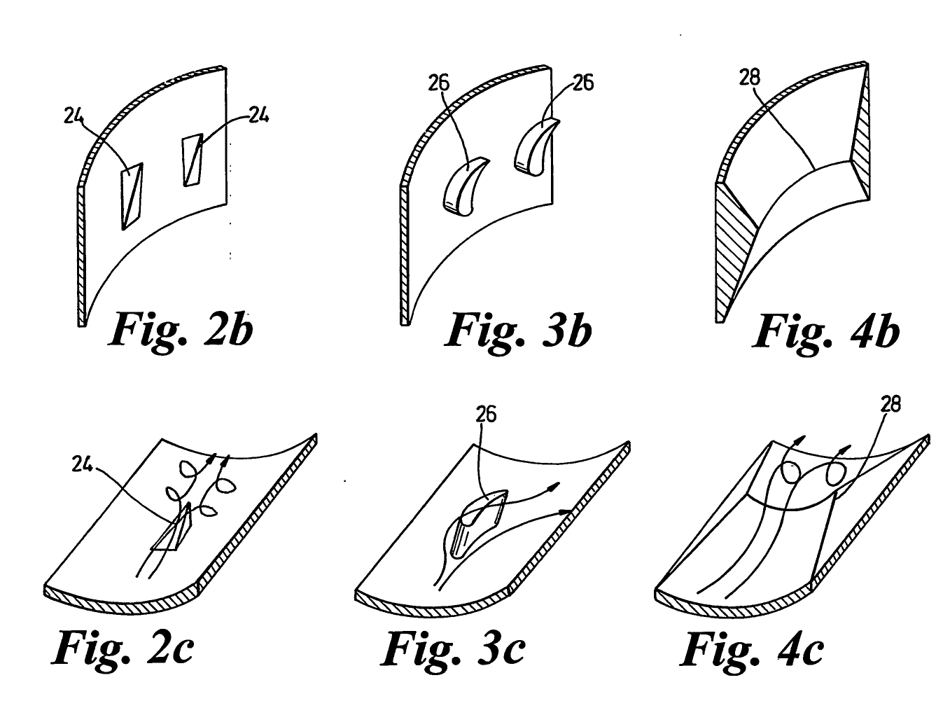

FIGS. 2a-2c show a flow homogeniser according to another embodiment of the invention;

FIGS. 3a-3c show a flow homogeniser according to a further embodiment of the invention;

FIGS. 4a-4c show a flow homogeniser according to a yet further embodiment of the invention; and

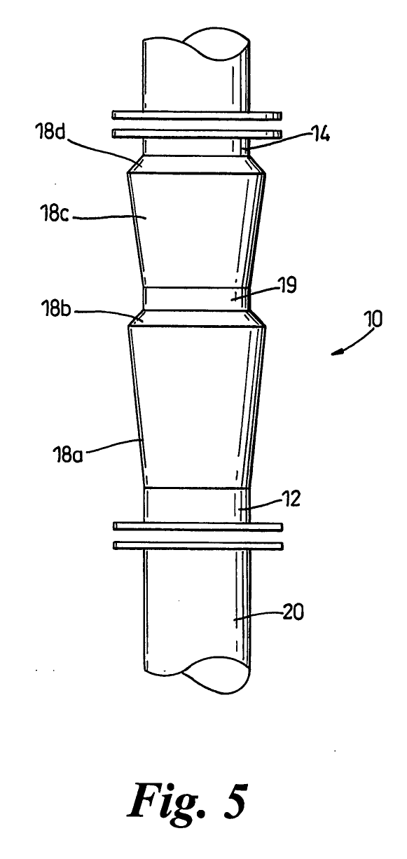

FIG. 5 shows a flow homogeniser according to a yet further embodiment of the invention.

A flow homogeniser 10 according to an embodiment of the invention is shown in FIG. 1. The flow homogeniser 10 is a pipe having an inlet end 12 and an outlet end 14, and includes a core 16 defined by one or more core pipe sections 18 connected in series between the inlet and outlet ends 12,14. The or each of the core pipe sections 18 defines a relatively gradual and/or rapid change in cross-sectional area.

In the embodiment shown in FIG. 1, the core 16 is defined by two core pipe sections 18a,18b connected in series between the inlet and outlet ends 12,14.

The first core pipe section 18a extends from the inlet end 12 and defines a gradual increase in cross-sectional area from a minimum cross-sectional area aᵢ at the inlet end 12 to a maximum cross-sectional area Aₘ at the junction with the second core pipe section 18b.

The second core pipe section 18b extends from the first core pipe section 18a and defines a rapid decrease in cross-sectional area from the maximum cross-sectional area Aₘ at the junction with the first core pipe section 18a to a minimum cross-sectional area aₒ at the outlet end 14.

The minimum cross-sectional areas aᵢ,aₒ at the inlet and outlet ends are preferably equal.

When the length l of the first core pipe section 18a is 1.5 times the hydraulic diameter d of the pipe at the inlet end 12, the hydraulic diameter D of the pipe section at the maximum cross-sectional area Aₘ is preferably 1.3 times the hydraulic diameter d of the pipe at the inlet end 12. These relative dimensions have been found to be particularly advantageous in pipelines transporting pulverised fuel using air as a carrier fluid in coal-fired power stations.

In other embodiments, the second core pipe section 18b may define a relatively gradual decrease in cross-sectional area from the maximum cross-sectional area Aₘ to a minimum cross-sectional area aₒ at the outlet end 14.

The inlet and outlet ends 12,14 may be defined by sections of pipe having a constant cross-sectional area, as shown in FIG. 1. Preferably the outlet end 14 is defined by a section of pipe having a constant cross-section, the length of the pipe section being equal to the hydraulic diameter of the cross-section of the pipe.

In use, the flow homogeniser 10 is inserted into a pipeline 20 transporting and distributing a particulate material in a carrier fluid. Preferably, the flow homogeniser 10 is inserted into a pipeline immediately upstream of a split (e.g. bifurcation, trifurcation, quadrafurcation and so on) or a riffler in the pipeline 20 in order to mix particulate material and carrier fluid to form an homogeneous mixture immediately upstream of the split.

On entry into the inlet end 12 of the flow homogeniser 10, the gradual increase in diameter of the first core pipe section 18a causes a reduction in the axial component of the carrier fluid velocity and an increase in the radial and tangential components of the carrier fluid velocity. It also causes an increase in carrier fluid pressure.

Such changes in the components of the carrier fluid velocity, and the increase in pressure in the carrier fluid, causes a reduction in the velocity of the rope and causes it to spread radially. This serves to break up any rope of particulate material entrained within the carrier fluid flow.

The decrease in cross-sectional area of the second core pipe section 18b causes an increase in the axial component of the carrier fluid velocity and a corresponding decrease in the radial and tangential components of the carrier fluid velocity. It also causes a decrease in carrier fluid pressure.

Such acceleration in the axial component of carrier fluid velocity, and the decrease in fluid pressure, mixes the particulate material with the carrier fluid in order to produce a homogeneous mixture on exit from the pipe section defining the outlet end 14. This rapid reduction in cross-sectional area obliges the flow to mix together.

The decrease in cross-sectional area of the second core pipe section 18b in the embodiment shown in FIG. 1 is relatively rapid. The decrease in cross-sectional area may be rapid or gradual depending on the nature of the particulate material and carrier fluid travelling through the device and therefore the acceleration in the carrier fluid required to mix the particulate material with the carrier fluid. For example, in a pipeline 20 transporting pulverised fuel using air as the carrier fluid, the second core pipe section preferably defines a relatively rapid decrease in cross-sectional area. Preferably, the wall of the pipe defines an angle of 45° relative to the axis of the pipe.

It is also envisaged that, in other embodiments, the first core pipe section may define a relatively rapid increase in cross-sectional area. The increase in cross-sectional area may be rapid or gradual depending on the nature of the particulate material and carrier fluid travelling through the device. For example, in a pipeline 20 transporting pulverised fuel using air as the carrier fluid, the first core pipe section preferably defines a relatively gradual increase in cross-sectional area. Preferably, the wall of the pipe defines an angle of 6° relative to the axis of the pipe.

Since the cross-sectional areas at the inlet and outlet ends aᵢ,aₒ are equal, the changes in pressure created by the first and second core pipe sections 18a,18b should be generally equal. This ensures that any change in carrier fluid pressure, and therefore carrier fluid flow rate, over the flow homogeniser is minimised.

In order to enhance the break-up of a rope of particulate material entrained within the carrier fluid, a flow control system 22 may be incorporated within the flow homogeniser 10.

In one embodiment, the flow control system 22 may include one or more wedge ramps 24 (FIG. 2b) located on the internal surface of the flow homogeniser 10 at the inlet end 12.

Preferably, in such embodiments, a plurality of wedge ramps 24 are spaced about the inner circumference of the flow homogeniser 10, at the inlet end 12, as shown in FIG. 2a.

The provision of one or more wedge ramps 24 at the inlet end 12 of the flow homogeniser 10 creates primary counter-rotating vortices in the boundary layer of the carrier fluid at the internal wall of the flow homogeniser 10, as shown in FIG. 2c.

This causes a reduction in the local axial component of the carrier fluid velocity, and increases in the local axial and tangential components of the carrier fluid velocity. A rope of particulate material entrained within the carrier fluid entering the inlet end 12 will therefore be divided into many small ropes rotating in different directions at the inlet end of the flow homogeniser 10. This assists in breaking up the rope of particulate material.

The size, number and spacing of wedge ramps 24 provided at the inlet end 12 may be varied depending on the nature of the particulate material and the properties of the carrier fluid entering the flow homogeniser 10.

In further embodiments, one or more wedge ramps 24 may be located at the outlet end 14 of the flow homogeniser to enhance the mix of particulate material with carrier fluid on exit of the carrier fluid from the outlet end 14.

In another embodiment, the flow control system 22 may include one or more aerofoils or deflectors 26 (FIG. 3b) located on the internal surface of the flow homogeniser 10 at the inlet end 12.

Preferably, in such embodiments, a plurality of aerofoils 26 are spaced about the inner circumference of the flow homogeniser 10, at the inlet end, as shown in FIG. 3a.

The or each aerofoil 26 is preferably arranged to point in the same direction as swirl created in the carrier fluid in its normal flow along the pipeline 20.

The provision of one or more aerofoils 26 at the inlet end 12 of the flow homogeniser 10 increases the swirling flow effect in the carrier fluid in entry into the flow homogeniser 10, as shown in FIG. 3c. This causes a reduction in the global axial component of the carrier fluid velocity and a dramatic increase in the global tangential component of the carrier fluid velocity.

The increase in the global tangential components of the carrier fluid velocity causes ejection of a rope of particulate material entrained within the carrier fluid at a considerable angle, facilitating the spread of the particulate material into the core 16 of the device. This assists in breaking up the rope of particulate material.

The size, number and spacing of aerofoils 26 provided at the inlet end 12 may be varied depending on the nature of the particulate material and the properties of the carrier fluid entering the flow homogeniser 10.

In further embodiments, one or more aerofoils 26 may be located at the outlet end 14 of the flow homogeniser 10 to enhance the mix of particulate material with carrier fluid on exit of the carrier fluid from the outlet end 14.

It is envisaged that, in other embodiments, one or more wedge ramps 24 may be provided at the inlet and/or outlet ends 12,14 in combination with one or more aerofoils 26.

In a yet further embodiment, the flow homogeniser 10 may include a flow control system 22 in the form of a tapered throat 28 (FIGS. 4a and 4b) formed at the inlet end 12.

The tapered throat 28 defines a rapid decrease in the internal cross-sectional area of the pipe before the gradual increase in cross-sectional area. This causes the creation of an inflexional profile in the boundary layer of carrier fluid at the internal wall of the flow homogeniser 10.

The inflexional profile leads to an instability in the wake, and creates a negative flow such that the flow of carrier fluid is mushroom-shaped. This causes re-circulation of the carrier fluid flow near the internal wall, as shown in FIG. 4c, which assists in breaking up the rope of particulate material.

In further embodiments, a tapered throat 28 may be formed at the outlet end 12 of the flow homogeniser to enhance the mix of particulate material with carrier fluid on exit of the carrier fluid from the outlet end 14.

It is envisaged that, in other embodiments, one or more wedge ramps 24 may be provided at the inlet and/or outlet ends 12,14 in combination with a tapered throat 28.

It is also envisaged that, in yet further embodiments, one or more aerofoils 26 may be provided at the inlet and/or outlet ends 12,14 in combination with a tapered throat 28.

Internal swirl enhancers in the form of air jets (not shown) may be included at the inlet end 12 of the flow homogeniser 10 to increase swirl in the particulate material entering the inlet end 12 of the flow homogeniser 10.

Such swirl enhancers may be included in addition to, or as an alternative to, a flow control system 22.

The flow homogeniser 10 may also include additional diffusers in the form of air jets (not shown) at the outlet end 14 to improve and increase the mixing of the particulate material with the carrier fluid, and thereby enhance the homogeneity of the two-phase flow.

Any such air jets may take the form of active air jets where an external supply of compressed air is injected into the flow homogeniser. Alternatively, in embodiments where the carrier fluid is air, any such air jets may take the form of passive air jets which suck air from the pipeline at a location upstream of the flow homogeniser for injection into the flow homogeniser.

In embodiments where the load of particulate material is relatively high (leading to a strong rope) and/or the velocity of the carrier fluid is relatively high, a double expansion within the flow homogeniser 10 may be provided, as shown in FIG. 5.

The flow homogeniser 10 shown in FIG. 5 includes first and second cores 16a,16b interconnected by a middle section 19. The first core 16a is defined by two core pipe sections 18a,18b connected in series between the inlet end 12 and the middle section 19. The second core 16b is defined by two core pipe sections 18c,18d connected in series between the middle section 19 and the outlet end 14.

The first core pipe section 18a extends from the inlet end 12 and defines a relatively gradual increase in cross-sectional area from a minimum cross-sectional area aᵢ to a maximum cross-sectional area A_{A} at the junction with the second core pipe section 18b. The second core pipe section 18b extends from the first core pipe section 18a and defines a relatively rapid decrease in cross-sectional area from the maximum cross-sectional area A_{A} at the junction with the first core pipe section 18a to a minimum cross-sectional area a_{w} at the junction with the middle section 19.

The third core pipe section 18c extends from the middle section 19 and defines a relatively gradual increase in cross-sectional area from the minimum cross-sectional area a_{w} to a maximum cross-sectional area A_{B} at the junction with the fourth core pipe section 18d. The fouth core pipe section 18d extends from the third core pipe section 18c and defines a relatively rapid decrease in cross-sectional area from the maximum cross-sectional area A_{B} at the junction with the third core pipe section 18c to a minimum cross-sectional area aₒ at the outlet end 14.

The minimum cross-sectional area aᵢ,a_{w},aₒ are preferably equal.

The inlet and outlet ends 12,14 may be defined by sections of pipe having a constant cross-sectional area, as shown in FIG. 5. Preferably the outlet end 14 is defined by a section of pipe having a constant cross-section, the length of the pipe section being equal to the hydraulic diameter of the cross-section of the pipe.

The middle section 19 may also be defined by a section of pipe having a constant cross-sectional area, as shown in FIG. 5. The middle section 19 may be used to house any wedge ramps 24, aerofoils 26, air jets and/or tapered throats which may be required in the flow homogeniser 10.

In use, the middle section 19 serves as a settling length between the first and second cores 16a,16b.

In the embodiment shown in FIG. 5, the first and second cores 16a,16b differ in length to each other. The maximum cross-sectional areas A_{A},A_{B} also differ to each other.

In other embodiments, the first and second cores 16a,16b may be the same length as each other, and the maximum cross-sectional areas A_{A},A_{B} may also be equal.

In yet further embodiments, the second and fourth core pipe sections 18b,18d may define relatively gradual decreases in cross-sectional areas from the maximum cross-sectional areas A_{A},A_{B} to the minimum cross-sectional area a_{w},aₒ respectively.

A flow homogeniser according to the invention is a passive rope breaker, enabling mixing of a particulate material with a carrier fluid without any external device or external energy consumption. It also ensures that any drop in the carrier fluid pressure across the flow homogeniser is minimal. For example, when the flow homogeniser 10 is inserted in a primary pipeline in a power station, the drop in carrier fluid pressure is in the order of 30-40 Pa when the conveying velocity of the carrier fluid is approximately 20-30 ms⁻¹. The carrier fluid may be a gas, and is preferably air. However, the invention is also applicable to arrangements where the carrier fluid is a liquid.

The combination of shape and size of cross-sections creates changes in the axial, radial and tangential components of the carrier fluid velocity which permits destruction of flow stratification.

1. A flow homogenizer for insertion in a pipeline conveying a particulate material carried by a carrier fluid comprising a pipe having an inlet end and an outlet end and including a core defined by one or more core pipe sections connected in series between the inlet end and the outlet end, each pipe section defining a relatively gradual or rapid change in cross-sectional area in order to mix particulate material and carrier fluid entering the inlet end to form a homogeneous mixture on exit from the outlet end.

2-21. (canceled)

22. A flow homogenizer according to claim 1 wherein the cross-sectional area of a core pipe section extending from the inlet end increases from the cross-sectional area of the inlet end to a relatively larger cross-sectional area.

23. A homogenizer according to claim 1 wherein the cross-sectional areas of the inlet and outlet ends are equal.

24. A flow homogenizer according to claim 1 wherein the core is defined by two core pipe sections, the first core pipe section defining a relatively gradual increase in cross-sectional area from an inlet cross-sectional area to a maximum cross-sectional area and the second core pipe section defining a relatively rapid decrease in cross-sectional area from the maximum cross-sectional area to an outlet cross-sectional area.

25. A flow homogenizer according to claim 1 wherein the core is defined by two core pipe sections, the first core pipe section defining a relatively gradual increase in cross-sectional area from an inlet cross-sectional area to a maximum cross-sectional area and the second core pipe section defining a relatively gradual decrease in cross-sectional area from the maximum cross-sectional area to an outlet cross-sectional area.

26. A flow homogenizer according to claim 1 wherein the core is defined by two core pipe sections, the first core pipe section defining a relatively gradual increase in cross-sectional area from an inlet cross-sectional area to a maximum cross-sectional area and the second core pipe section defining a relatively rapid decrease in cross-sectional area from the maximum cross-sectional area to an outlet cross-sectional area, the length of the first core pipe section being 1.5 times the diameter of the core at the inlet end and the diameter of the core at the junction between the first and second core pipe sections being 1.3 times the diameter of the core at the inlet end.

27. A flow homogenizer according to claim 1 wherein the core is defined by two core pipe sections, the first core pipe section defining a relatively gradual increase in cross-sectional area from an inlet cross-sectional area to a maximum cross-sectional area and the second core pipe section defining a relatively gradual decrease in cross-sectional area from the maximum cross-sectional area to an outlet cross-sectional area, the length of the first core pipe section being 1.5 times the diameter of the core at the inlet end and the diameter of the core at the junction between the first and second core pipe sections being 1.3 times the diameter of the core at the inlet end.

28. A flow homogenizer according to claim 1 wherein the core is defined by two core pipe sections, the first core pipe section defining a relatively rapid increase in cross-sectional area from an inlet cross-sectional area to a maximum cross-sectional area and the second core pipe section defining a relatively rapid decrease in cross-sectional area from the maximum cross-sectional area to an outlet cross-sectional area.

29. A flow homogenizer according to claim 1 wherein the core is defined by two core pipe sections, the first core pipe section defining a relatively rapid increase in cross-sectional area from an inlet cross-sectional area to a maximum cross-sectional area and the second core pipe section defining a relatively gradual decrease in cross-sectional area from the maximum cross-sectional area to an outlet cross-sectional area.

30. A flow homogenizer according to claim 1 wherein the core is defined by four core pipe sections and a middle section, the first and second core pipe sections being connected in series between the inlet end and the middle section, and the third and fourth core pipe sections being connected in series between the middle section and the outlet end, the first core pipe section defining a gradual increase in cross-sectional area from an inlet cross-sectional area to a first maximum cross-sectional area, the second core pipe section defining a relatively rapid decrease in cross-sectional area from the first maximum cross-sectional area to a middle cross-sectional area, the third core pipe section defining a relatively gradual increase in cross-sectional area from the middle cross-sectional area to a second maximum cross-sectional area and the fourth core pipe section defining a relatively rapid decrease in cross-sectional area from the second maximum cross-sectional area to an outlet cross-sectional area.

31. A flow h6omogenizer for insertion in a pipeline conveying a particulate material carried by a carrier fluid comprising a pipe having an inlet end and an outlet end and including a core defined by one or more core pipe sections connected in series between the inlet end and the outlet end, each core pipe section defining a relatively gradual or rapid change in cross-sectional area in order to mix particulate material and carrier fluid entering the inlet end to form a homogeneous mixture on exit from the outlet end, the flow homogenizer further including a flow control system located at the inlet end.

32. A flow homogenizer for insertion in a pipeline conveying a particulate material carried by a carrier fluid comprising a pipe having an inlet end and an outlet end and including a core defined by one or more core pipe sections connected in series between the inlet end and the outlet end, each core pipe section defining a relatively gradual or rapid change in cross-sectional area in order to mix particulate material and carrier fluid entering the inlet end to form a homogeneous mixture on exit from the outlet end, the flow homogenizer further including a flow control system located at the outlet end.

33. A flow homogenizer according to claim 31 wherein the flow control system includes at least one wedge-shaped ramp on an inner surface of the pipe.

34. A flow homogenizer according to claim 32 wherein the flow control system includes at least one wedge-shaped ramp on an inner surface of the pipe.

35. A flow homogenizer according to claim 31 wherein the flow control system includes a plurality of wedge-shaped ramps spaced about the inner circumference of the inner surface of the pipe.

36. A flow homogenizer according to claim 32 wherein the flow control system includes a plurality of wedge-shaped ramps spaced about the inner circumference of the inner surface of the pipe.

37. A flow homogenizer according to claim 31 wherein the flow control system includes at least one aerofoil on an inner surface of the pipe.

38. A flow homogenizer according to claim 32 wherein the flow control system includes at least one aerofoil on an inner surface of the pipe.

39. A flow homogenizer according to claim 31 wherein the flow control system includes a plurality of aerofoils spaced about the inner circumference of the inner surface of the pipe.

40. A flow homogenizer according to claim 32 wherein the flow control system includes a plurality of aerofoils spaced about the inner circumference of the inner surface of the pipe.

41. A flow homogenizer according to claim 31 wherein the inner surface of the input pipe section is shaped to define a flow control system in the form of a tapered throat.

42. A flow homogenizer according to claim 32 wherein the inner surface of the input pipe section is shaped to define a flow control system in the form of a tapered throat.

43. A flow homogenizer according to claim 31 wherein the flow control system includes a combination of one or more wedge-shaped ramps, one or more aerofoils and/or a tapered throat.

44. A flow homogenizer according to claim 32 wherein the flow control system includes a combination of one or more wedge-shaped ramps, one or more aerofoils and/or a tapered throat.

45. A flow homogenizer according to claim 1 further including one or more air jets at the inlet end.

46. A flow homogenizer according to claim 31 further including one or more air jets at the inlet end.

47. A flow homogenizer according to claim 32 further including one or more air jets at the inlet end.

48. A flow homogenizer according to claim 1 further including one or more air jets at the outlet end.

49. A flow homogenizer according to claim 31 further including one or more air jets at the outlet end.

50. A flow homogenizer according to claim 32 further including one or more air jets at the outlet end.
